(19) United States
(12) Patent Application Publication
(10) Pub. No.: US 2008/0036961 A1
(43) Pub. Date: Feb. 14, 2008

(54) Clip-on frames or lenses with a hybrid attachment-detachment mechanism

(76) Inventor: Qingshan Zhou, Irvine, CA (US)

Correspondence Address: Qingshan Zhou, 11 Suncreek, Irvine, CA, 92604, US

(21) Appl. No.: 11/500,716

(22) Filed: Aug. 8, 2006

(51) Int. Cl. G02C 9/00

(52) U.S. Cl. 351/47

(57) ABSTRACT

The present invention relates to novel auxiliary sunglasses which can be easily attached to and detached from the frame of a pair of primary eyeglasses. Specifically, this invention utilizes a hybrid mounting mechanism, for example, one side of the auxiliary sunglasses uses a mechanic attachment mechanism while the other side uses a magnetic attraction mechanism. This combination of two different attachment mechanisms on the same pair of the auxiliary sunglasses overcomes the problems associated with each of the mechanic mounting only or the magnetic mounting only mechanisms respectively.

### BACKGROUND OF THE INVENTION

Auxiliary sunglasses, such as Clip-on (hereafter auxiliary frames and Clip-on will be used interchangeably) are widely used today because of its simplicity and convenience. A pair of prescribed eyeglasses (hereafter referred as primary eyeglasses) can be converted into sunglasses by mounting a pair of auxiliary UV blocking lenses at the front of the primary eyeglasses. As the wearer enters into an indoor environment, the auxiliary frame can be easily detached from the primary eyeglasses. Although there have numerous prior art patents describing various methods for mounting Clip-on frames in front of a pair of primary eyeglasses, they can be generally divided into two attachment mechanisms: mechanic mechanism and magnetic mechanism.

For the mechanic mechanism, it utilizes a mechanic device to attach the Clip-on frames in front of the primary eyeglasses. For example, Sieberg in U.S. Pat. No. 6,557,997 disclosed hooked fingers to mount the Clip-on to the frame of the primary eyeglasses (see FIG. 1). Once the Clip-on frame is mounted on the primary eyeglasses, the hooks are firmly clamped on the primary eyeglasses. However, it is almost impossible to attach or detach the four hooks simultaneously onto the frame of the primary eyeglasses. Instead, they have to be clamped on stepwise. Usually, the hooks on the first side of the frame can be easily mounted onto the primary eyeglasses (left side is shown as the first side of the frame in FIG. 2). To mount the second side (i.e. the right side in FIG. 2) onto the primary eyeglasses, it requires to shift the hooks of the second side beyond the frame of the primary eyeglasses, then release back to allow the hooks of the second side to clamp onto the frame of the primary eyeglasses (see FIG. 2). This over shift (toward to right side) maneuver usually requires both hands to coordinate well for accomplishing the mounting work because the bridge wire, which connects the two lenses of the Clip-on frame, is not made from a stretchable material.

To dismount the Clip-on frame, it is equally difficult. One has to slide the Clip-on frame toward one side to allow the hooks on the first side to dismount from the frame of the primary eyeglasses, then, shift the Clip-on to the opposite side to dismount the hooks of the second side from the frame of the primary eyeglasses. Furthermore, the bridge length has to be precisely made because too short will not allow the Clip-on to be mounted or dismounted easily and too long will not be able to attach the Clip-on firmly in front of the primary eyeglasses.

To overcome the disadvantage of Sieberg's invention, Friedman in U.S. Pat. No. 6,685,314 disclosed another Clip-on design wherein the bridge wire comprises a spring structure. The spring bridge will allow the Clip-on frame to be over stretched to allow the hooks of the second side to be easily mounted onto the frame of the primary eyeglasses. In addition, the spring also makes the Clip-on frame to be length adjustable to fit over primary eyeglasses for patients with various pupil-to-pupil distances. However, such spring designs still require two hands operation; they are not cosmetically appearing for customers because the spring structure adds to the bulky appearance of the bridge structure; and their cost is relatively high because of the extra work for making the springs and their assembly time.

For magnetic mechanism, it utilizes the magnetic attraction force to hold a Clip-on frame in front of the primary eyeglasses. Many US patents disclosed various ways for attaching Clip-on frames in front of a pair of primary eyeglasses. For example, Zelnan in U.S. Pat. Nos. 6,705,722, 6,550,913, 6,450,637, 6,343,858, disclosed a method and apparatus for mounting auxiliary sunglasses in front of a pair of conventional eyeglasses in which magnets attached to appendages of the auxiliary sunglasses mating with magnets mounted on the temple extensions of conventional eyeglasses (see FIG. 3). Xie in U.S. Pat. Nos. 6,834,951, 6,761,449, 6,729,723, 6,382,787, disclosed a magnetic mating position different from Zelman's. In Xie's invention, the magnetic mating positions are on or near nose pads of a pair of conventional eyeglasses. In comparison with Clip-on of a mechanic attachment mechanism, the advantage of the magnetic attachment is that the Clip-on frame can be easily attached or detached, often requiring only one hand to accomplish the job. However, the surface of the mating magnets is generally flat. Therefore, if there is an external force parallel to the mating surface, the clip-on frame can be easily detached or simply fall off the primary eyeglasses. To overcome this problem, Fukuwa in U.S. Pat. No. 6,742,889 disclosed an alternative design wherein two mating magnets on each side of the temple extensions are approximately perpendicular each other to prevent Clip-on frames from incidental fall off. However, by adding a second magnetic pair, it significantly increased production cost. Furthermore, the added a second mating magnet is on the vertical plane as the Clip-on lens surface in the temple position, an aesthetically inferior design (see FIG. 4).

In summary, Clip-on frames with a mechanical mounting mechanism provide a firm attachment but the problem is that it is difficult for mounting to and dismounting from the primary eyeglasses. They usually require both hands operation with good coordination. On the other hand, a magnetic mounting mechanism provides an easy method for mounting and dismounting but the magnetic attachment force is weak. As a result, a magnetic Clip-on frame can incidentally fall off. Furthermore, the manufacturing cost can be high if double mating magnets perpendicular each other are used and their cosmetic appearance is inferior to single magnet design. Accordingly, there is a need to provide a pair of improved auxiliary sunglasses which overcome the problems associated with the pure mechanic mounting mechanism and pure magnetic mounting respectively.

### SUMMARY OF THE INVENTION

The present invention utilizes a hybrid mounting mechanism, such as that one side the Clip-on frame has a mechanic mounting mechanism and the other side utilizes magnetic attraction mechanism. It is surprisingly discovered that this hybrid mechanism retains the best features of each of the individual mounting mechanism while it avoids the problems associated with each of the individual mechanism respectively.

The primary object of the present invention is to provide a pair of auxiliary sunglasses or lenses which can be easily attached to and detached from the frame of a pair of primary eyeglasses. Once they are attached to the front of a pair of primary eyeglasses, the auxiliary sunglasses or lenses are firmly positioned in place to prevent incidental displacement or falling off.

Another object of this invention is to provide a pair of auxiliary sunglasses which are comprised of two individual lens members wherein each individual lens member can be easily attached to and detached from the frame of a pair of primary eyeglasses. Once the individual lens is attached to the primary eyeglasses, it is firmly positioned without displacement or falling off.

A still another object of this invention is to provide various cosmetically appealing designs for auxiliary sunglasses, such as frameless sunglasses lenses as the Clip-on for attaching onto a pair of the primary eyeglasses. This way, one pair of primary eyeglasses can be converted into Clip-on sunglasses with different designs by changing the design of the auxiliary sunglasses structure.

A further object of this invention is to provide the auxiliary sunglasses which can be easily and economically manufactured.

These objects can be achieved by the hybrid mounting mechanism for the Clip-on frames and these achievements can be demonstrated through the preferred embodiments and Figures below.

### BRIEF DESCRIPTION OF THE DRAWINGS

FIG. 1 is a prior art Clip-on design utilizing mechanical attachment mechanism wherein a pair of hooks (not shown) on each side of the lenses of the Clip-on frame clamp onto the primary eyeglasses.

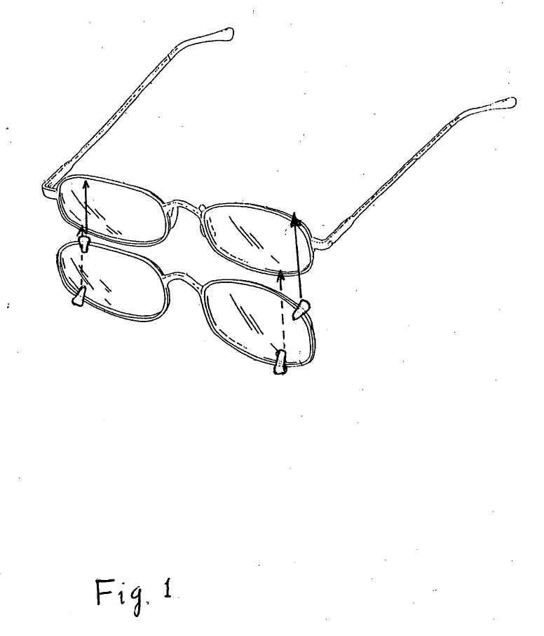

FIG. 2 shows the prior art mounting process. The first step is to mount the first pair of hooks (i.e. left side hooks) onto the frame of the primary eyeglass. The second step is to mount the second pair of hooks onto the frame of the primary eyeglasses. To do this, the auxiliary sunglasses frame needs to be shifted sidewise toward to the right-hand side, then releasing back to allow the second pair of hooks clamp on the frame of the primary eyeglasses.

FIG. 3. is a prior art Clip-on design with typical magnetic mating attachment mechanism.

FIG. 4 is another prior art design show two mating magnets approximately perpendicular each other on each side of the temple extension to allow the auxiliary sunglasses frame to be firmly attached to the frame of the primary eyeglasses.

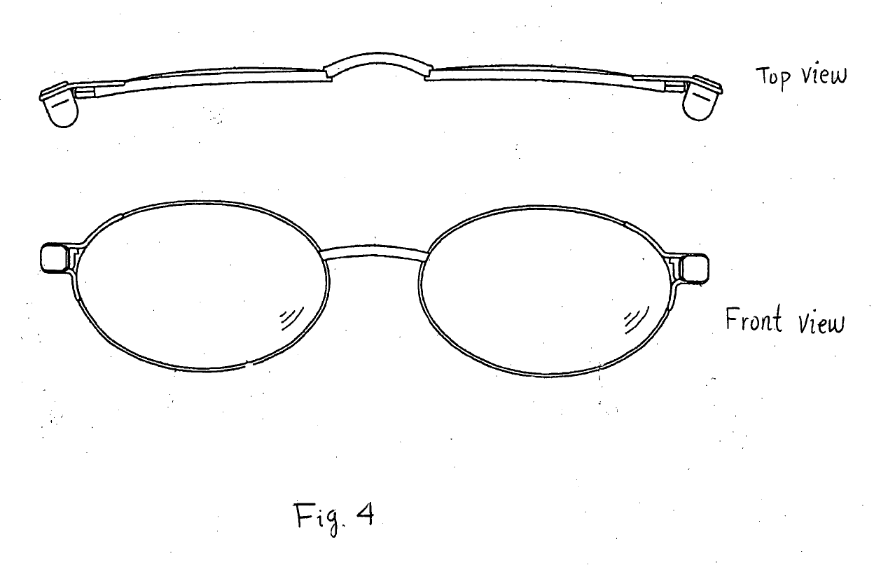

FIG. 5 is a preferred embodiment of the present invention which shows the first side of the auxiliary frame has a mechanic engagement device while the second side of the auxiliary frame has a magnetic attraction.

FIG. 6 is another embodiment of the present invention wherein the mechanic engagement device is a hook engaging with the notch in the horizontal plane.

FIG. 7 is another embodiment of the present invention wherein two individual lenses are used as the auxiliary sunglasses. Each lens member respectively has a mechanic engagement device and a magnetic attraction for firmly attaching to the front of a pair of primary eyeglasses.

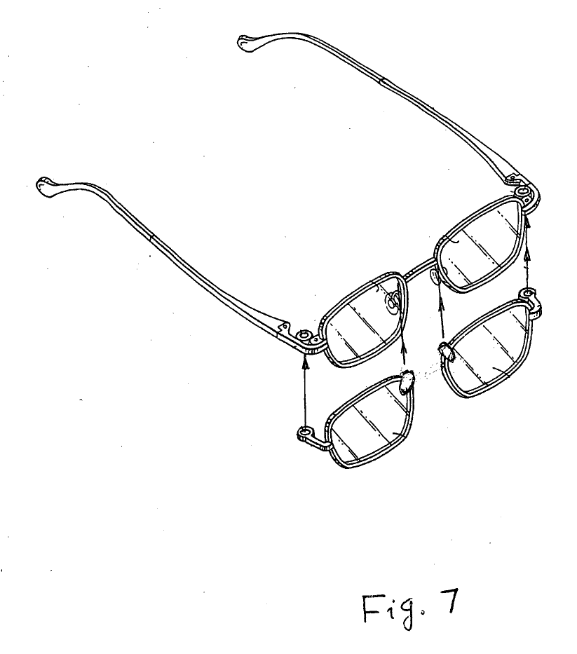

FIG. 8 is another embodiment of the present invention which shows a frameless auxiliary lens can only be achieved by a separate auxiliary lens method.

### DETAILED DESCRIPTION OF THE INVENTION

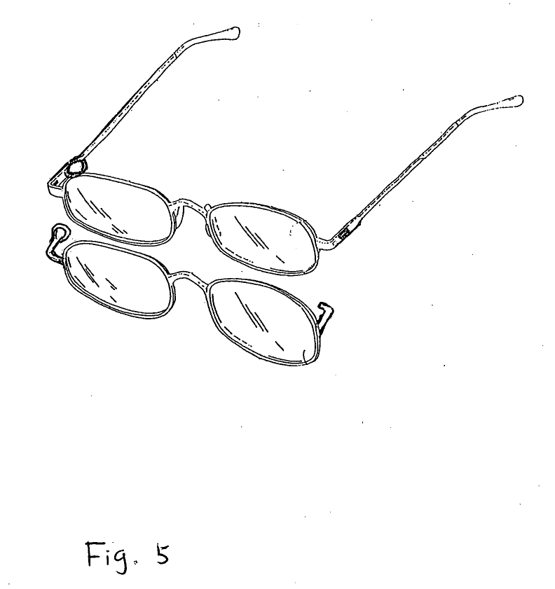

In one preferred embodiment of the present invention shown in FIG. 5, a first side of the auxiliary frame has a mechanic device for attaching to the corresponding first side of the frame of a pair of primary eyeglasses while the second side of the auxiliary frame has a magnetic mechanism for attaching to the corresponding second side of the frame of the same primary eyeglasses. As explained in the background section of this invention, the auxiliary frame with mechanical mounting devices on both sides provides a firm attachment but problem is that it is very difficult to mount to and dismounting from the primary eyeglasses. On the other hand, an auxiliary frame with magnetic mounting devices on both sides provides an easy method for mounting and dismounting but the attachment is weak. In this preferred embodiment, the hybrid mounting mechanism overcomes problems associated with the pure mechanical mounting or the pure magnetic mounting respectively but preserves advantages of both individual mounting mechanisms. This is achieved by the following mounting and dismounting procedures: To mount the auxiliary frame to the primary eyeglasses, it is necessary to engage the mechanic device into position first, then to mate the magnetic parts together. To dismount, the magnetic parts need to be disengaged first by separating them apart, then, the mechanic device can easily disengaged.

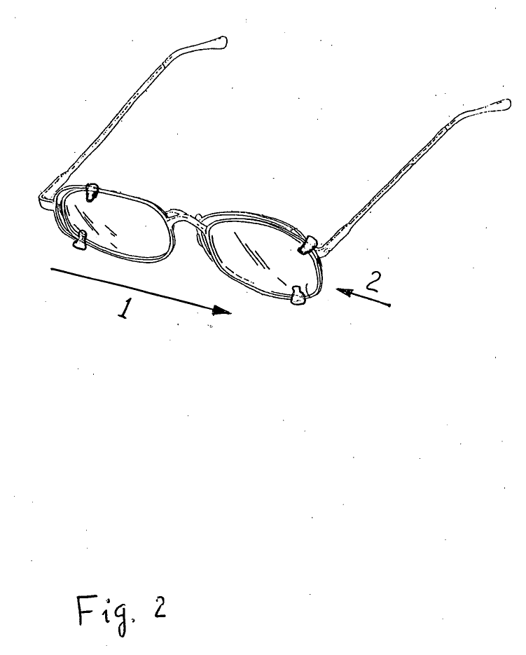

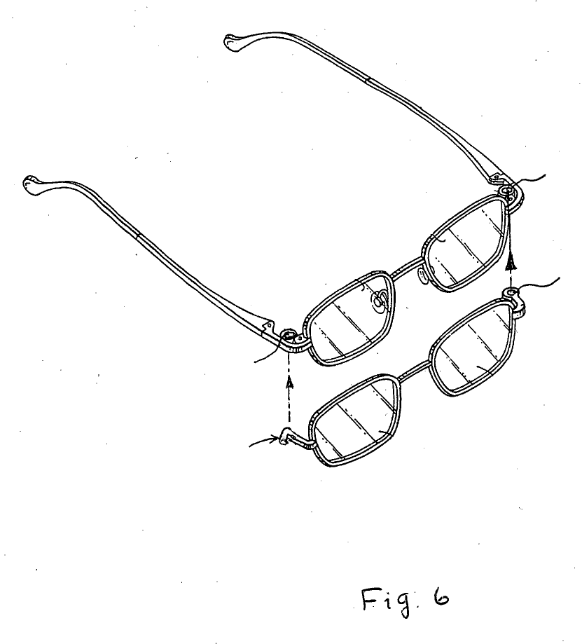

The mechanic engagement device for the auxiliary frame of the present invention can have different designs. For example, it can be a simple hook fitting into the matching hole next to the temple extension of the primary eyeglasses, such as one as shown in FIG. 5 and FIG. 6. It can also be a hook to clamp on the first side of the frame of the primary eyeglasses. The hooks can be similar to that shown in FIG. 2. The hooks can be customer prepared to be precisely matching the frame thickness of the primary eyeglasses in order to provide a tight fit. It is important to note that such as tight fit is possible for the hybrid design of the present invention, but is not possible for a design wherein both sides have the same mechanic engagement mechanism. This is because in the later case, the first hook can always be easily clamped on the first side of the frame of the primary eyeglasses. If it has a tight fit, it simply becomes impossible to shift towards the other side in order to mount the second side onto the frame of the primary eyeglasses (see FIG. 2). An exception to this will be the case wherein the bridge connecting the two lenses is made from a stretchable elastic material or has s spring structure which allows the bridge to be stretched for allowing the Clip-on frame to be shifted for the second pair of hooks clamping into the frame of the primary eyeglasses.

On the other hand, for the magnetic mounting devices of the auxiliary frame of the present invention can be chosen from one of several designs previously disclosed in the prior art (examples include but not limited to: U.S. Pat. Nos. 6,705,722; 6,550,913; 6,450,637; 6,343,858; 6,834,951, 6,761,449, 6,729,723, 6,382,787) and herein included by reference.

To mount the auxiliary frame of the present invention, it is preferred that the mechanic device, whether it is on the right side of the frame or left side of the frame, needs to be engaged with the primary eyeglasses first to ensure a firm and tight attachment and then the magnetic attraction is placed together by positioning the magnet on the auxiliary frame in contact with the magnet located in the temple area of the primary eyeglasses. To dismount, the magnetic attraction side will preferably be detached first and then the mechanic attachment will be disengaged for completely removing the auxiliary frame from the primary eyeglasses.

Although the two sides of the auxiliary frame have different engagement mechanisms, it is possible and preferable that the auxiliary frame as well as the corresponding primary eyeglasses are manufactured in a cosmetically symmetric fashion. For example, the auxiliary frame in the FIG. 6, once mounted on the primary eyeglasses, it becomes visibly indistinguishable whether from the front view or from the side view.

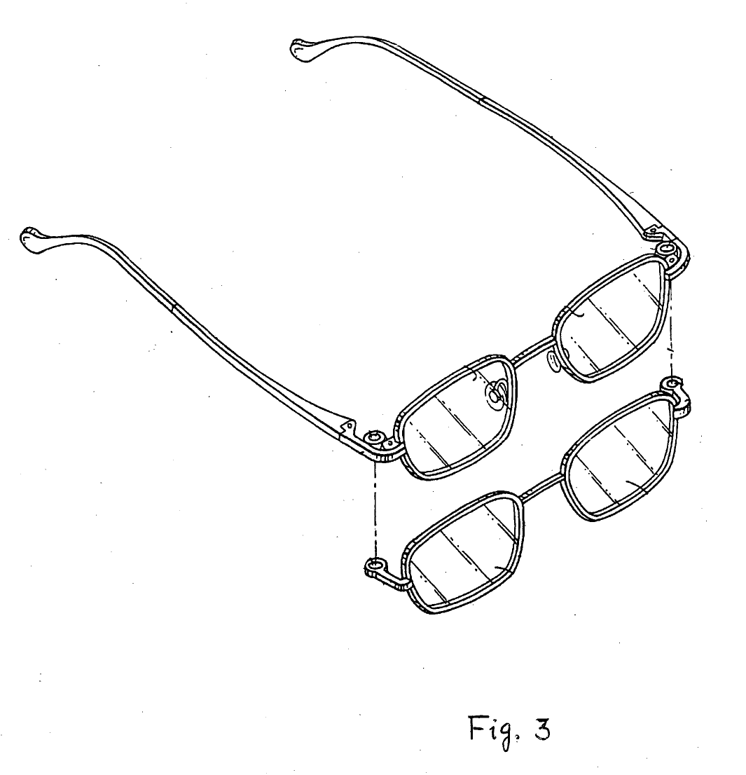

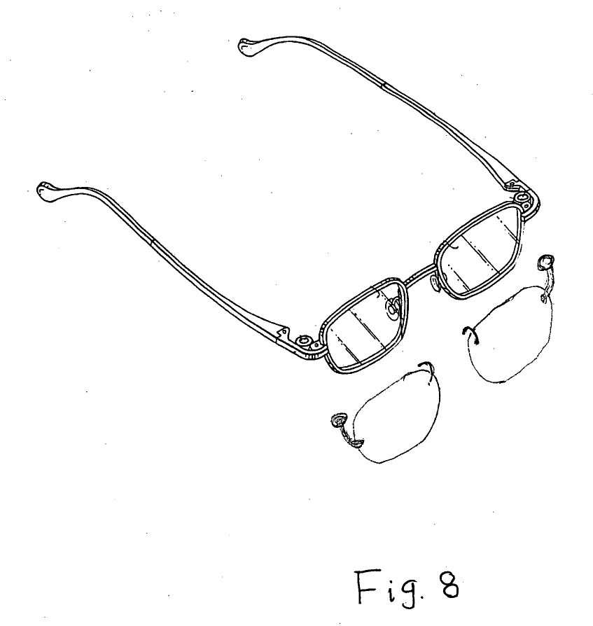

In another preferred embodiment of the present invention, the auxiliary glasses are two separate lenses wherein each lens has a mechanic device and a magnetic device to respectively engage with the corresponding mechanic device and magnetic device of the frame of the primary eyeglasses. The mechanic device can be various designs, such as a hook made of metal or plastics preferably covered with a rubber sleeve to prevent potential damage to the frames of the primary eyeglasses. The magnetic device has a similar structure as the one demonstrated in FIG. 3. To mount the lens onto the primary eyeglasses, the first step is to engage the mechanic device of the auxiliary lens with the frame of the primary eyeglasses then to mate the magnet on the auxiliary lens with the magnet of the primary eyeglasses in the temple area of the frame extension. In this way, each auxiliary lens can be mounted onto the frame of the primary eyeglasses separately. Although it takes additional time to mount and dismount the auxiliary lenses onto the frame of a primary eyeglasses, this design provides some fashionable frame designs which cannot be accomplished by other engagement mechanism. These fashionable designs include but not limited to a frameless lens (see FIG. 8).

1. An eyewear assembly comprising a pair of primary eyeglasses and auxiliary sunglasses wherein said auxiliary sunglasses can be removeably attached to the front of said primary prescribed eyeglasses and said auxiliary sunglasses utilize at least two different attachment mechanisms.

2. The eyewear assembly of claim 1 wherein said primary eyeglasses are prescribed glasses for the correction of myopia, hyperopia, or astigmatism or a combination thereof.

3. The eyewear assembly of claim 1 wherein said auxiliary sunglasses comprise a pair of lenses and a bridge for connecting said pair lenses.

4. The eyewear assembly of claim 3 wherein said lenses are selected from ultraviolet light absorbing lenses, polarized lenses, blue light blocking lenses, and a combination thereof.

5. The eyewear assembly of claim 1 wherein said auxiliary sunglasses comprising a pair of lenses connected by a bridge and wherein said attachment mechanisms comprising of:
(a) a mechanic device on the first side of said bridge for engaging with the corresponding counterpart of said primary eyeglasses, and
(b) a magnet on the second side of said bridge for mating with the corresponding counterpart of said primary eyeglasses.

6. The eyewear assembly of claim 5 wherein said primary eyeglasses are prescribed glasses for the correction of myopia, hyperopia, or astigmatism or a combination thereof.

7. The eyewear assembly of claim 5 wherein said lenses are selected from ultraviolet light absorbing lenses, polarized lenses, blue light blocking lenses, and a combination thereof.

8. The eyewear assembly of claim 5 wherein said mechanic device of said auxiliary sunglasses is a hook which inserts into a notch in the temple area of the frame of the primary eyeglasses.

9. The eyewear assembly of claim 5 wherein said mechanic device of said auxiliary sunglasses has two hooks which clamp directly onto the lens or lens frame of said primary eyeglasses.

10. The eyewear assembly of claim 1 wherein said auxiliary sunglasses comprising two separate lenses not connected by a bridge and wherein each of said two separate lenses having a hybrid attachment mechanism comprising of:
(a) a mechanic device for engaging with the corresponding counterpart of said primary eyeglasses, and
(b) a magnet for mating with the corresponding counterpart of said primary eyeglasses.

11. The eyewear assembly of claim 10 wherein said primary eyeglasses are prescribed glasses for the correction of myopia, hyperopia, or astigmatism or a combination thereof.

12. The eyewear assembly of claim 10 wherein said lenses are selected from ultraviolet light absorbing lenses, polarized lenses, blue light blocking lenses, and a combination thereof.

13. The eyewear assembly of claim 10 wherein said mechanic device is a hook which clamps onto the nose bridge of said primary eyeglasses.

14. The eyewear assembly of claim 10 wherein said mechanic device is a hook which clamps onto the lens or the lens frame of said primary eyeglasses.
